(19) United States
(12) Patent Application Publication
(10) Pub. No.: US 2013/0169508 A1
(43) Pub. Date: Jul. 4, 2013

(54) ANTENNA AND ELECTRONIC DEVICE USING THE SAME

(71) Applicants: SHU-WEI CHANG, Tu-Cheng (TW); HSIN-HUNG LIU, Tu-Cheng (TW); FU-HSIUNG YANG, Tu-Cheng (TW)

(72) Inventors: SHU-WEI CHANG, Tu-Cheng (TW); HSIN-HUNG LIU, Tu-Cheng (TW); FU-HSIUNG YANG, Tu-Cheng (TW)

(73) Assignee: HON HAI PRECISION INDUSTRY CO., LTD., Tu-Cheng (TW)

(21) Appl. No.: 13/563,759

(22) Filed: Aug. 1, 2012

(30) Foreign Application Priority Data
Dec. 28, 2011 (TW) 100149073

(51) Int. Cl. H01Q 1/50

(52) U.S. Cl. 343/906

(57) ABSTRACT

An antenna for use in an electronic device includes an antenna body and two elastic conductors, the antenna body is attached to the inside wall of the electronic device, includes a feeding-in portion and a grounding portion, the feeding-in portion is connected to a printed circuit board through a elastic conductor for feeding-in, and the grounding is connected to the printed circuit board for grounding.

### BACKGROUND

1. Technical Field

The present disclosure relates to an antenna, and particularly to an antenna that connects to the printed circuit board through elastic conductor for feeding-in and grounding.

2. Description of Related Art

Portable electronic devices are being made lighter and thinner, and many components of the electronic device are arranged in the thin housing of electronic device. Thus, there is a very small space left for antenna. The antenna is usually connected to the printed circuit board via a cable. Although such antennas can satisfy basic requirements, a new type of antenna and an electronic device using the antenna are still needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a partial, isometric view of an electronic device, including an antenna, in accordance with an exemplary embodiment.

FIG. 2 is an isometric view of an elastic conductor of the antenna of FIG. 1.

FIGS. 3-4 show the electronic device in different viewpoints, with some elements omitted for clarity.

### DETAILED DESCRIPTION

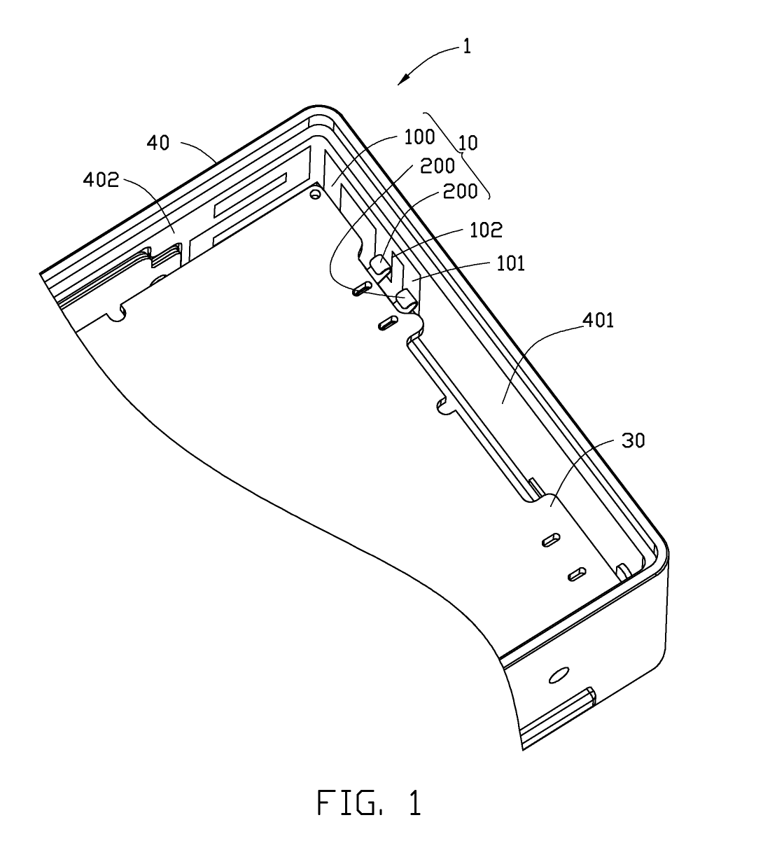

FIG. 1 is a schematic view of an electronic device 1 with an antenna 10. The electronic device 1 includes an antenna 10, a printed circuit board (PCB) 30, and a housing 40. The antenna 10 includes an antenna body 100 and two elastic conductors 200. Because a liquid crystal display (not shown) and a battery (not shown) are arranged on opposite sides the PCB 30, there is very small space left for the antenna 10.

In the embodiment, the antenna body 100 of the antenna 10 is affixed on two inside walls 401 and 402 of the electronic device 1. The antenna body 100 is a flexible printed circuit radiation structure, and includes a feeding-in portion 101 and a grounding portion 102 both affixed on the inside wall 401. The feeding-in portion 101 and the grounding portion 102 are elongated, thin sheets that are in the same plane and spaced apart from each other. The feeding-in portion 101 is connected to the PCB 30 through one elastic conductor 200 for feeding-in and the grounding portion 102 is connected to the printed circuit board 30 through one elastic conductor 200 for grounding.

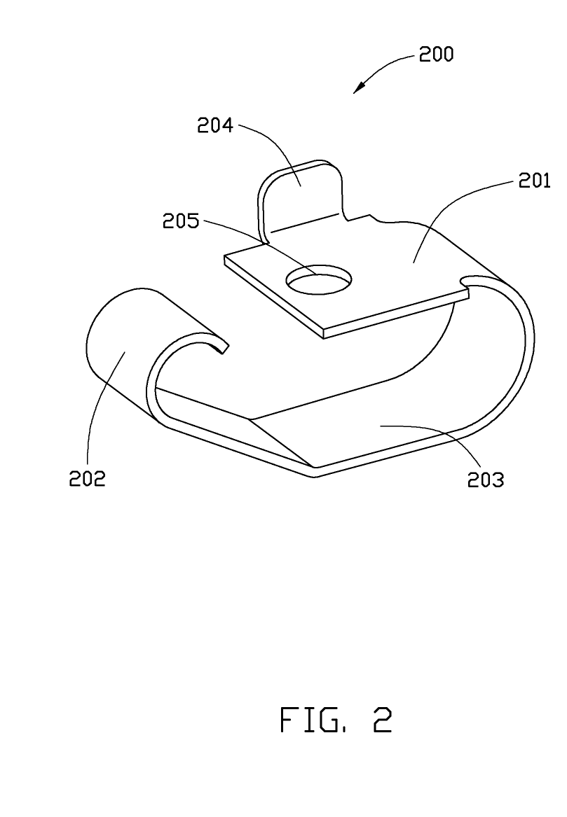

FIG. 2 is a schematic view of an elastic conductor 200. In the embodiment, the elastic conductor 200 is a single curved spring metal sheet, and includes a first end portion 201, a second end portion 202, and a conduction portion 203. The first end portion 201 is configured for connecting to the PCB 30, the second end portion 202 is configured for connecting to the feeding-in portion 101 or the grounding portion 102 of the antenna body 100, and the conduction portion 203 is configured for connecting the first end portion 201 to the second end portion 202. The first end portion 201 is a tablet-shaped sheet with a positioning tab 204 protruding upwardly from an edge thereon. The first end portion 201 further defines a fixing hole 205 in the center. A bolt or a screw is screwed into the fixing hole 205 to fix the elastic conductor 200 to the PCB 30. In an alternative embodiment, the elastic conductor 200 also could be fixed to the PCB 30 by welding.

The second end portion 202 is an arc-shaped sheet and elastically abuts against the feeding-in portion 101 or the grounding portion 102. The conduction portion 203 consists of an arc portion and a planar portion. The arc portion is connected to the first end portion 201, and the plane portion is connected to the second end portion 202. The elastic conductor 200 is made of copper, and in other embodiments, the elastic conductor 200 may be made of other suitable material, such as iron, aluminum, or silver.

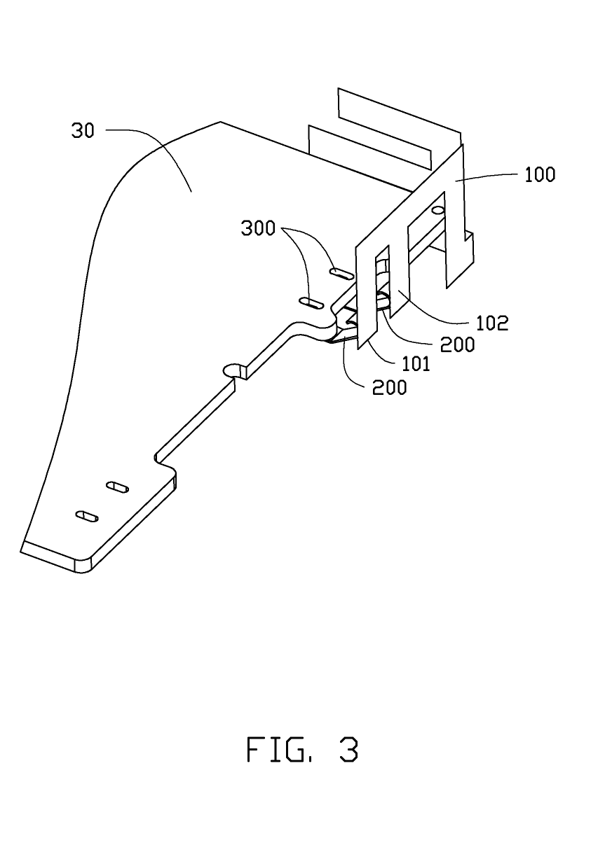

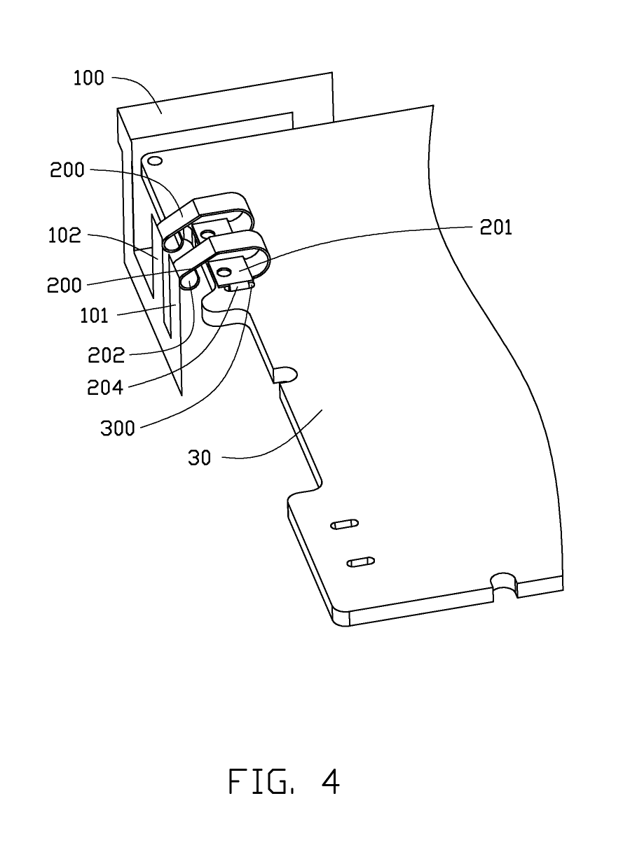

FIGS. 3-4 are isometric views of the antenna body 100 of FIG. 1 connected to the PCB 30 by two elastic conductors 200 of FIG. 2 and please referring also to FIG. 2. The two elastic conductors 200 are positioned on the PCB 30 by positioning tab 204 and the positioning hole 300 on the PCB 300. The first end portions 201 of the two elastic conductors 200 both are fixed on the PCB 30 by welding or screws, the second end portion of one elastic conductor 200 elastically abuts against the feeding-in portion 101 and the first end portion of the other elastic conductor 200 elastically abuts against the grounding portion 102. The antenna 100 is electrically connected to the PCB through the two elastic conductors for feeding-in and grounding.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An antenna for use in an electronic device, comprising:
an antenna body comprising a feeding-in portion and a grounding portion; and
two elastic conductors respectively connecting the feeding-in portion and the grounding portion to a printed circuit board of the electronic device, wherein, each of the two elastic conductors comprises a first end portion and a second end portion, the first end portions of the two elastic conductors both are fixed on the printed circuit board of the electronic device, the second end portion of one of the two elastic conductors elastically abuts against the feeding-in portion and the second end portion of the other elastic conductor elastically abuts against the grounding portion.

2. The antenna as described in claim 1, wherein the antenna body is a flexible circuit board radiation structure, and arranged on the inside wall of the electronic device.

3. The antenna as described in claim 2, wherein the feeding-in portion and the grounding portion are elongated, thin sheets that are in the same plane and spaced apart a distance from each other.

4. The antenna as described in claim 1, wherein the elastic conductor is a single curved spring metal sheet, the first end portion is tablet-shaped sheet with a protruding tab protruded upwardly from its edge and defines a fixing hole in the center, and the second end portion is an arc-shaped sheet.

5. The antenna as described in claim 4, wherein the elastic conductor is fixed on the printed circuit board by screw or welding.

6. The antenna as described in claim 4, wherein the elastic conductor is made of copper.

7. A portable electronic device, comprising:
a printed circuit board;
an antenna comprising:
an antenna body comprising a feeding-in portion and a grounding portion; and
two elastic conductors for respectively connecting the feeding-in portion and the grounding portion to a printed circuit board of the electronic device, each of the two elastic conductors comprises a first end portion and a second end portion, the first end portions of the two elastic conductors both are fixed on a printed circuit board of the electronic device, the second end portion of one of the two elastic conductors elastically abuts against the feeding-in portion and the second end portion of the other elastic conductor elastically abuts against the grounding portion.

8. The electronic device as described in claim 7, wherein the antenna body is flexible circuit board radiation structure, and is arranged on the inside wall of the electronic device.

9. The electronic device as described in claim 7, wherein the feeding-in portion and the grounding portion are elongated, thin sheets that are in the same plane and spaced apart a distance from each other.

10. The electronic device as described in claim 7, wherein the elastic conductor is a single curved spring metal sheet comprising a first end portion and a second end portion, the first end portion is a tablet-shaped sheet with a protruding tab protruded upwardly from its edge and defines a fixing hole in the center, and the second end portion is an arc-shaped sheet.

11. The electronic device as described in claim 10, wherein the elastic conductor is fixed on the printed circuit board by screw or welding.

12. The electronic device as described in claim 10, wherein the elastic conductor is made of copper.
